(19) United States
(12) Patent Application Publication
(10) Pub. No.: US 2018/0249707 A1
(43) Pub. Date: Sep. 6, 2018

(54) METHOD OF CONTROLLING ALGAE IN A BODY OF WATER

(71) Applicant: Arch Chemicals, Inc., Allendale, NJ (US)

(72) Inventors: Rahim HANI, Alpharetta, GA (US); Maria R. PRIOLI, Alpharetta, GA (US); Ryan WERSAL, Cumming, GA (US); Mirtha URIBE, Doraville, GA (US)

(21) Appl. No.: 15/974,129

(22) Filed: May 8, 2018

Related U.S. Application Data
(63) Continuation of application No. 14/567,525, filed on Dec. 11, 2014, now abandoned.
(60) Provisional application No. 61/914,687, filed on Dec. 11, 2013.

(51) Int. Cl. A01N 33/04; C02F 1/50; A01N 59/20; C02F 103/00

(52) U.S. Cl. CPC A01N 33/04; C02F 2103/007; A01N 59/20; C02F 1/50

(57) ABSTRACT

A method of treating algae in a body of water is disclosed. The method includes adding an amine compound to the body of water in amounts ≤4 parts per million as an effective algaecide.

### CROSS-REFERENCE TO RELATED APPLICATION

This application is a Continuation of U.S. patent application Ser. No. 14/567,525, filed Dec. 11, 2014, which claims priority under 35 U.S.C. § 119(e) from Provisional Application No.: 61/914,687, filed Dec. 11, 2013, the disclosure of each of which is incorporated herein by reference.

### FIELD OF THE INVENTION

The present invention relates to a method of treating a body of water with a composition to control algae.

### BACKGROUND OF THE INVENTION

Aquatic environments, such as lakes, ponds and canals, are frequently subject to excessive plant growth, including algae, which blocks the circulation of water and leads to water stagnation. As fertilizers and growth promoters wash into the water from agricultural land, the problem becomes more severe as plant growth increases. Other aqueous environments, such as swimming pools, shower rooms and water storage tanks are often polluted by algal growth, which affects the color of the water and can be harmful to water users and those near water containing algae. Algae growth or algae blooms in lakes, ponds and other bodies of water can be particularly harmful due to the toxins released by some species of algae. These released toxins can be harmful to aquatic life in the body of water and animals and/or humans which may be near the body of water or venture into the body of water. In addition, algae often deprives users of the body of water from enjoying the body of water recreationally and commercially, since algae can make the body of water unusable for recreational uses, such as boating, swimming and/or fishing, or for commercial uses such as irrigation water, fishing and the like.

Copper containing compositions have been used to effectively control algae in bodies of water. However, outside the United States copper-based algaecides have largely been banned from use, and in the United States copper use has come under increased regulatory pressure. Currently, there are few other non-copper based algaecides available, one such is sodium percarbonate peroxyhydrate, but it is limited in effectiveness as compared to copper-base algaecides.

Amines have been suggested as algaecides for water application, such as cooling tower water recirculating systems. However, the amount of the amine being suggested is relatively high, more than 10 ppm and more typically in the range of about 15-100 ppm. See, e.g., U.S. Pat. No. 2,393,293, and U.S. Pat. No. 3,247,053. However, these patents do not suggest treating surface water with the amines in amounts taught herein.

Accordingly, there is a need in the art to provide an effective algaecide and a method of controlling algae in bodies of water with a copper-free algaecide which is as effective or as nearly effective against algae as currently available copper-based algaecides, in amounts that are safe for the aquatic environment. The present disclosure provides an answer to those needs.

### BRIEF DESCRIPTION OF THE DRAWINGS

FIG. 1 shows the chlorophyll a concentrations of Microcystis aeruginosa 15 days after exposure to concentrations of an amine of formula (1) compared to a copper-based algaecide.

FIG. 2 shows the chlorophyll a concentrations of Cladophora sp. 15 days after exposure to concentrations of an amine of formula (1) compared to a copper-based algaecide.

FIG. 3 shows the fresh weight biomass of Cladophora sp. 15 days after exposure to concentrations of an amine of formula (1) compared to a copper-based algaecide.

### SUMMARY OF THE INVENTION

In one aspect, the present invention provides a method controlling algae in a body of water. The method has the step of adding an amine or a salt of an amine to the body of water in an effective amount to control the growth of algae in the body of water. The amine is an amine having general formula (1)

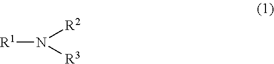

or a salt thereof
wherein
R¹ is a substituted or unsubstituted C₆₋₃₀ alkyl; and
R² and R³ are each independently a hydrogen atom, a substituted or unsubstituted hydrocarbyl group having between 1 and 20 carbon atoms.

In a particular embodiment of the present invention, the amine used in the method is dodecylamine or a salt of dodecylamine. In another embodiment, the amine is a N,N-bis-(3-aminopropyl) dodecylamine.

In a further embodiment of the present invention, the amine or amine salt is added to the body of water in an amount of about 0.001 to 4 or less parts per million (ppm) (or milligrams per liter (mg/l)), based on the volume of the water being treated. Typically, the composition containing the amine is added such that the amount of the amine or amine salt is in the range of about 0.001 ppm to about 2 ppm, more typically in an amount of about 0.01 ppm to about 1.8 ppm. In one particular embodiment, the amine or amine salt is added to the water to be treated in an amount of about 0.2 to about 0.8 ppm.

These and other aspects will become apparent when reading the detailed description of the invention.

### DETAILED DESCRIPTION OF THE PREFERRED EMBODIMENTS

It has now been surprisingly found that a composition containing an amine as described herein is an effective algaecide in bodies of water, even at low doses, meaning under 4 or less ppm (≤4 mg/l).

Amines useable in the composition added to the body of water are amines having the general formula (1)

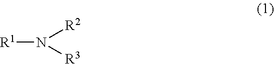

wherein R¹ is a substituted or unsubstituted C₆₋₃₀ alkyl; and

R² and R³ are each independently a hydrogen atom, a substituted or unsubstituted hydrocarbyl group having between 1 and 20 carbon atoms. Exemplary hydrocarbyl groups are aliphatic hydrocarbyl groups having between 1 and 20 carbons, more typically straight chain hydrocarbyl groups having between 2 and 20 carbon atoms. As used herein, the term “substituted hydrocarbyl group” is intended to include hydrocarbyl groups bearing substituents such as amine; an aryl; a halogen such as a chloro, a iodo, a fluoro or a bromo atom; an alkoxy such as methoxy, ethoxy, propoxy or butoxy; nitro; thio; and other similar groups. Further, mixture of amines having the general formula (1) may also be used, provided that the total amount of the amines is with the amounts specified herein.

In a particular embodiment, R¹ is a C₈₋₁₆ alkyl group and R² and R³ are each a hydrogen atom or amine substituted hydrocarbyl group have 1-6 carbon atoms. In an exemplary embodiment, R¹ is a dodecyl group and R² and R³ are each a hydrogen atom or amine substituted hydrocarbyl group having the formula

—CH₂—CH₂—CH₂—NH₂.

In addition to the amines of formula (1), salts of amine of formula may also be used. Exemplary salts include HCl salts and the like. The salt may be used alone or in combination with the amine of formula (1).

The amines have been found to be effective in controlling both planktonic and filamentous forms of algae. Species of algae which have been discovered that can be controlled by the amine include, but are not limited to, Cladophora sp. and Microcystis aeruginosa.

Generally, the amine of formula (1) is added to the body of water is relatively small amounts. Typically, the amine or amine salt is added to the body of water in an amount of about 0.001 to 4 or less parts per million (ppm) (or milligrams per liter (mg/l)), based on the volume of the water being treated. More typically, the composition containing the amine is added such that the amount of the amine or amine salt is in the range of about 0.001 ppm to about 2 ppm, more typically in an amount of about 0.01 ppm to about 1.8 ppm. In one particular embodiment, the amine or amine salt is added to the water to be treated in an amount of about 0.2 to about 0.8 ppm. It has been unexpectedly discovered that small amounts of the amine is effective is controlling algae in bodies of water. Conventional teachings suggest that algae may be controlled using amines at much higher doses.

Generally, the amine is provided as a composition with the amine being one component of the composition. The composition containing the amine may be formed as a concentrate which is diluted prior to application to a body of water. The amine may be placed in a solvent such as glycols, water or other similar solvents which will assist in dispersing the amine in the body of water to be treated.

The composition containing the amine may optionally contain additional components including herbicides, colorants, adjuvants, and other algaecides, provided that the additional components do not adversely affect the amine of formula (1), or salt thereof, as an algaecide. Exemplary herbicides include, for example 2,4-Dichlorophenoxyacetic acid (commonly called “2,4 D”), dichlorophenoxyacetic acid or derivative thereof, bispyribac-sodium, carfentrazone-ethyl, diquat, endothall, flumioxazin, fluridone, glyphosate, imazamox, imazapyr, penoxsulam, triclopyr, topramezone, or mixtures thereof. Exemplary colorants include, for example, colorants commercially available under the Aquashade®, and Aquashadow® brands available from Applied Biochemist, as well as other similar colorants. Suitable adjuvants include ingredients such as ionic surfactants, crop oils, methylated seed oils, d-limonene and the like. Other algaecides include copper-based algaecides and non-copper based algaecides. Alternatively, these additional ingredients may be applied to the body of water separately from the amine or salt of general formula (1), but applied concurrently with the amine or salt or within few hours or a few days before or after the application of the amine.

The amine of formula (1), or salt thereof, may also be mixed with other algaecides, including copper-based algaecides and non-copper based algaecides. By blending the amine of formula (1), or salt thereof, with other algaecides, the amount of the other algaecide may be reduced. Other algaecides can include copper sulphate; chelated copper compounds, such as those described in U.S. Pat. No. 3,930,834, and U.S. Pat. No. 5,407,899, both of which are hereby incorporated by reference in their entirety; non-copper algaecides such as sodium carbonate peroxyhydrate and a blend of Acid Blue 9 and Acid Yellow 23, sold under the name Aquashade®, are examples of non-copper algaecides in which the amine of formula (1) or salt thereof maybe blended. Alternatively, these additional algaecides may be applied to the body of water separately from the amine or salt of general formula (1), but applied concurrently with the amine or salt or within few hours or a few days before or after the application of the amine.

Typically, the amine of general formula (1) is applied to bodies of water on the surface earth, commonly called “surface water”, meaning a body of water where the water is in direct contact with the terrain of the earth. Exemplary bodies of water include lakes, ponds, canals, and slow flowing streams, creeks and rivers, industrial storage reservoirs, waste water reservoirs, and potable water sources such as reservoirs. The amine of the present invention may be applied to the body of water being treated using any suitable application means including, spraying, control release, subsurface injection, liquid or solid application broadcast across the body of water and the like.

Generally, the amine of general formula (1) can be applied as a one-time treatment or may be applied in a treating regimen, such as a weekly, bi-weekly, monthly, bi-monthly, quarterly or seasonably. The treatment regimen will be on an as-needed basis.

The present invention is further described in detail by means of the following Examples. All parts and percentages are by weight and all temperatures are degrees Celsius unless explicitly stated otherwise.

### EXAMPLES

### Example 1

Procedure

This assay is performed to determine the minimum inhibitory concentration (“MIC”) of a compound necessary to completely inhibit the growth of a particular microorganism using an amine of the present invention and a commercially available copper based algaecide Cutrine® Plus, available from Applied Biochemists, Germantown, Wis.

MICs for the samples against M. aeruginosa were determined in a standard 96-well microtiter plate assay in BG-11 with a starting inoculum of ˜1×10⁵ cells/mL. Algae plates were incubated for 10 days. MIC concentrations were determined visually, in vivo chlorophyll a was determined fluorometrically, and cell density was determined via direct counting. Samples were tested in duplicate. Following are the results of testing M. aeruginosa UTEX 2385 and are reported in TABLES 1A, 1B, 2A and 2B. The resulting MIC values are reported in TABLE 3.

TABLE 1A
In vivo chlorophyll a of M. aeruginosa (μg/L)
(Initial time = 0; 0.1 ug/L)

| | Active ppm | | | | | |
|---|---|---|---|---|---|---|
| | 0.5 | 0.25 | 0.125 | 0.063 | 0.031 | 0 |
| 1-dodecylammonium | 0.00 | 0.15 | 2.05 | 4.65 | 7.20 | 9.25 |
| chloride | | | | | | |
| dodecylamine | 0.00 | 0.35 | 2.60 | 5.75 | 7.85 | 9.25 |

TABLE 1B
In vivo chlorophyll a of M. aeruginosa (μg/L)
(Initial time = 0; 0.1 ug/L)

| | Active ppm | | | | | |
|---|---|---|---|---|---|---|
| | 0.125 | 0.063 | 0.031 | 0.016 | 0.008 | 0 |
| Cutrine ® Plus | 0.00 | 0.05 | 2.75 | 6.35 | 9.00 | 9.25 |

TABLE 2A
Cell density of M. aeruginosa (cells/mL) (Initial
time = 0; 1.03 × 10⁵ cells/ml)

| | Active ppm | | | | | |
|---|---|---|---|---|---|---|
| | 0.5 | 0.25 | 0.125 | 0.063 | 0.031 | 0 |
| 1-dodecyl- | <1 × | 2.58 × | 2.30 × | 5.23 × | 7.90 × | 9.25 × |
| ammonium | 10⁴ | 10⁵ | 10⁶ | 10⁶ | 10⁶ | 10⁶ |
| chloride | | | | | | |
| dodecylamine | <1 × | 6.50 × | 3.15 × | 7.85 × | 8.28 × | 9.25 × |
| | 10⁴ | 10⁵ | 10⁶ | 10⁶ | 10⁶ | 10⁶ |

TABLE 2B
Cell density of M. aeruginosa (cells/mL) (Initial
time = 0; 1.03 × 10⁵ cells/ml)

| | Active ppm | | | | | |
|---|---|---|---|---|---|---|
| | 0.125 | 0.063 | 0.031 | 0.016 | 0.008 | 0 |
| Cutrine ® Plus | <1 × | 4.50 × | 6.85 × | 7.35 × | 8.95 × | 9.25 × |
| | 10⁴ | 10⁴ | 10⁶ | 10⁶ | 10⁶ | 10⁶ |

Results

TABLE 3
MIC values (ppm) per individual sample

| Sample | M. aeruginosa |
|---|---|
| 1-dodecylammonium chloride | 0.25 |
| dodecylamine | 0.25 |
| Cutrine ® Plus (copper based algaecide) | 0.063 |

Based upon MIC values, no difference in efficacy was observed between 1-dodecylammonium chloride and dodecylamine.

### Example 2

This example shows the response of Microcystis aeruginosa to exposure of dodecylamine (DDA) and Cutrine® Plus (a copper based algaecide). The experiment was conducted for 15 days and was initiated using 100 mL BG-11 medium contained in 200 mL flasks. The Microcystis aeruginosa had an initial density of 4.5×10⁴ cells/mL. The experiment was initiated by exposing the algae to 0.1, 0.2, 0.4, 0.8, and 1.6 mg/L as DDA, 0.2, 0.6, 1.0 mg Cu/L Cutrine®-Plus, and combinations of DDA and Cutrine®-Plus. Due to the low solubility of DDA, the treatment stock solution was made using a 2% DMSO solution as the solvent. The solution was heated in a water bath and diluted to 70 mg/L using warmed deionized water. The concentration of DMSO was approximately 350 mg/L in the test beakers. Cutrine®-Plus stock solution was made at 50 mg/L using deionized water. Three replicates of each exposure concentration, along with three replicates of an untreated reference were tested. Each sample was Maintained at room temperature with 12-hours of light and 12-hours dark photo period. The results are shown in TABLE 4.

TABLE 4
Cell densities of Microcystis aeruginosa 15 days after

| Treatment (mg/L) | Cell Densities (cells/mL) |
|---|---|
| Reference | 4.8 × 10⁶ |
| DDA 0.1 | 5.2 × 10⁶ |
| DDA 0.2 | 6.7 × 10⁶ |
| DDA 0.4 | 8.0 × 10⁵ |
| DDA 0.8 | <10000 |
| DDA 1.6 | <10000 |
| Cutrine ®-Plus 0.2 | <10000 |
| Cutrine ®-Plus 0.6 | <10000 |
| Cutrine ®-Plus 1.0 | <10000 |
| DDA 0.2 + Cutrine 0.2 | <10000 |
| DDA 0.4 + Cutrine 0.2 | <10000 |

As can be seen in TABLE 4, Dodecylamine applied at 0.4 mg/L resulted in a 1 log reduction in M. aeruginosa cells by 15 days after start. The concentration of 0.8 mg/L DDA provided similar control to all of the Cutrine®-Plus treatments.

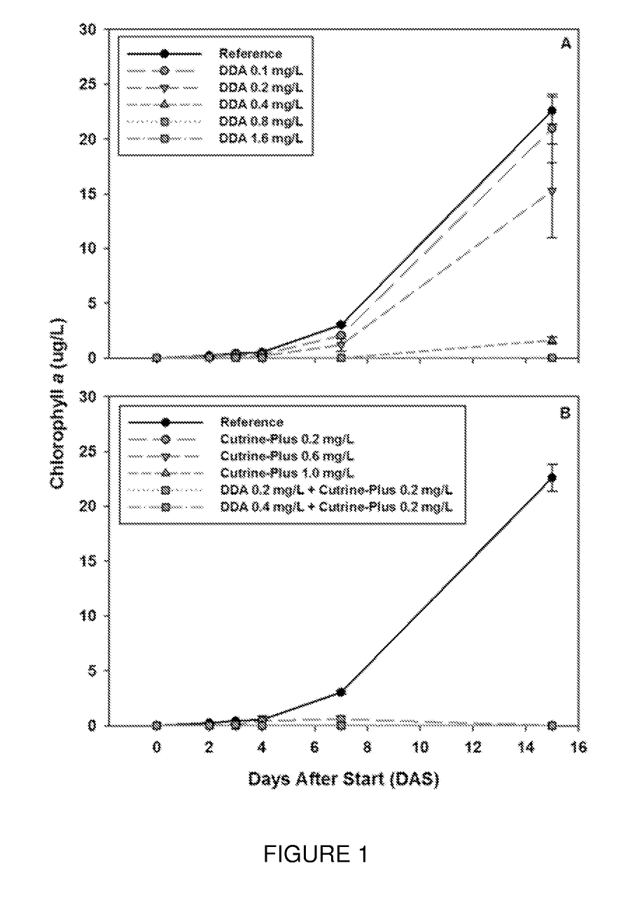

As is shown in FIG. 1, the chlorophyll a concentrations of Microcystis aeruginosa through the 15 day exposure after exposure to concentrations of DDA and Cutrine®-Plus.

### Example 3

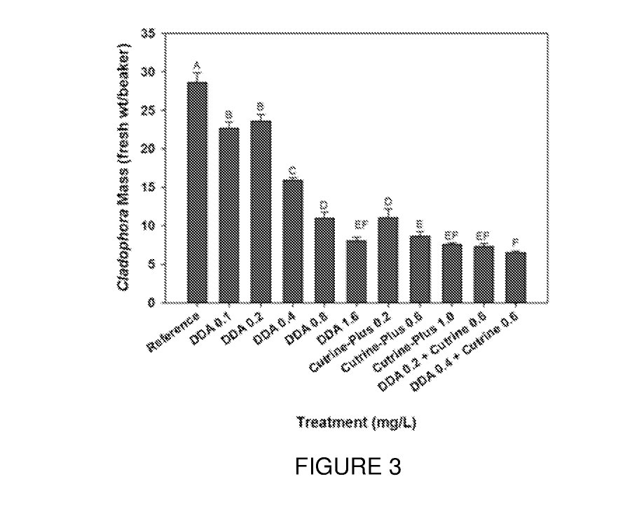

This example shows the response of Cladophora sp. to exposure of dodecylamine (DDA) and Cutrine® Plus. The experiment was conducted for 15 days and was initiated using 100 mL BG-11 medium contained in 200 mL flasks. The Cladophora sp. had an initial density of 3 filaments/mL. The experiment was initiated by exposing the algae to 0.1, 0.2, 0.4, 0.8, and 1.6 mg/L as DDA, 0.2, 0.6, 1.0 mg Cu/L Cutrine®-Plus, and combinations of DDA and Cutrine®-Plus. Due to the low solubility of DDA, the treatment stock solution was made using a 2% DMSO solution as the solvent. The solution was heated in a water bath and diluted to 70 mg/L using warmed deionized water. The concentration of DMSO was approximately 350 mg/L in the test beakers. Cutrine®-Plus stock solution was made at 50 mg/L using deionized water. Three replicates of each exposure concentration, along with three replicates of an untreated reference were tested. Each sample was Maintained at room temperature with 12-hours of light and 12-h dark photoperiod. The results are shown in FIG. 3, which shows the fresh weight biomass of Cladophora sp. 15 days after exposure. The Bars in FIG. 3 sharing the same letter are not different according to Fishers Protected LSD test at p≤0.05 significance level.

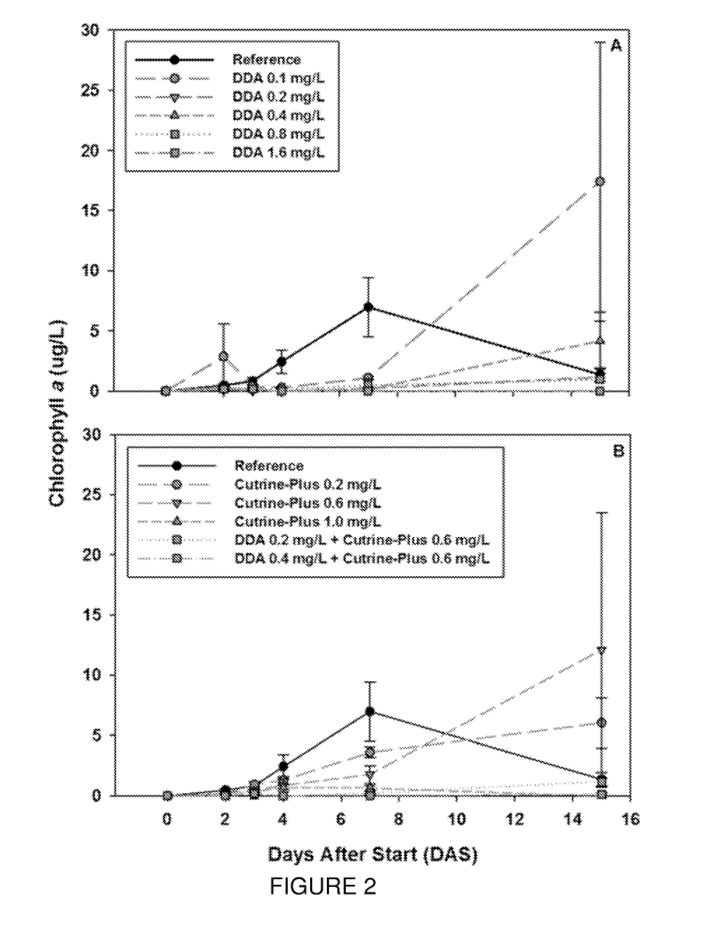

FIG. 2 shows the chlorophyll a concentrations of Cladophora sp. through the 15 day period after exposure to concentrations of DDA and Cutrine®-Plus.

As is shown in the above examples, Dodecylamine (DDA) is effective as an algaecide on both Microcystis aeruginosa and Cladophora sp. at concentrations comparable to the copper containing algaecide Cutrine®-Plus. Chlorophyll a content of M. aeruginosa by 15 days after start showed that the application of DDA at concentrations of 0.2 to 1.6 ppm (mg/L) reduced (p<0.01) chlorophyll when compared to untreated reference algae. Furthermore, when DDA was applied at 0.4 to 1.6 mg/L chlorophyll a results were similar to Cutrine®-Plus applied at 0.2 to 1.0 ppm (mg/L). Cell count data indicates that a concentration of 0.8 mg/L DDA would be necessary to achieve similar results as Cutrine®-Plus with respect to M. aeruginosa control, though a 1 log difference in cell concentration was observed at the 0.4 mg/L treatment when compared to untreated reference algae after 15 days.

### Example 4

This example shows the response of Microcystis aeruginosa to exposure of N,N-bis-(3-aminopropyl) dodecylamine (BADA). The experiment was conducted for 14 days and was initiated using 100 mL BG-11 medium contained in 200 mL flasks. The Microcystis aeruginosa had an initial density of 4.5×10⁴ cells/mL. The experiment was initiated by exposing the algae to 0.2, 0.4, 0.8, 1.0, 1.2, 1.4, 1.8, and 2.0 ppm (mg/L) as BADA, 0.5 Cu/L Cutrine®-Plus. The solution was heated in a water bath and diluted to 70 mg/L using warmed deionized water. Cutrine®-Plus stock solution was made at 50 mg/L using deionized water. Three replicates of each exposure concentration, along with three replicates of an untreated reference were tested. Each sample was maintained at room temperature with 12-hours of light and 12-h dark photoperiod. The chlorophyll a concentrations of Microcystis aeruginosa through the 14 day exposure after exposure to concentrations of BADA and Cutrine®-Plus. The results are shown in TABLES 5, and 6, which show the chlorophyll a concentration and the cell density, respectively.

TABLE 5
In vivo chlorophyll a concentrations (μg/L) of M. aeruginosa cultures

| | BADA | | | | | | | | Cutrine ® | Control |
|---|---|---|---|---|---|---|---|---|---|---|
| Time | 0.2 | 0.4 | 0.8 | 1.0 | 1.2 | 1.4 | 1.8 | 2.0 | Plus | 0 |
| (days) | ppm | ppm | ppm | ppm | ppm | ppm | ppm | ppm | ppm | ppm |
| 0 | 0.90 | 0.90 | 0.90 | 0.90 | 0.90 | 0.90 | 0.90 | 0.90 | 0.90 | 0.90 |
| 3 | 0.28 | 0.23 | 0.26 | 0.31 | 0.29 | 0.29 | 0.32 | 0.40 | 0.11 | 1.14 |
| 7 | 0.06 | 0.03 | 0.03 | 0.05 | 0.04 | 0.04 | 0.03 | 0.03 | 0.03 | 2.50 |
| 14 | 0.02 | 0.02 | 0.02 | 0.02 | 0.02 | 0.01 | 0.02 | 0.01 | 0.02 | 10.16 |

TABLE 6
Cell density of M. aeruginosa cultures (cells/mL)

| | BADA | | | | | | | | Cutrine ® | Control |
|---|---|---|---|---|---|---|---|---|---|---|
| Time | 0.2 | 0.4 | 0.8 | 1.0 | 1.2 | 1.4 | 1.8 | 2.0 | Plus | 0 |
| (days) | ppm | ppm | ppm | ppm | ppm | ppm | ppm | ppm | ppm | ppm |
| 0 | 5.7E+05 | 5.7E+05 | 5.7E+05 | 5.7E+05 | 5.7E+05 | 5.7E+05 | 5.7E+05 | 5.7E+05 | 5.7E+05 | 5.7E+05 |
| 7 | <1E+04 | <1E+04 | <1E+04 | <1E+04 | <1E+04 | <1E+04 | <1E+04 | <1E+04 | <1E+04 | 3.3E+06 |
| 14 | <1E+04 | <1E+04 | <1E+04 | <1E+04 | <1E+04 | <1E+04 | <1E+04 | <1E+04 | <1E+04 | 1.3E+07 |

### Example 5

This example shows the response of Cladophora sp. to exposure of N,N-bis-(3-aminopropyl) dodecylamine (BADA). The experiment was conducted for 14 days and was initiated using 100 mL BG-11 medium contained in 200 mL flasks. The Cladophora sp. had an initial density of 3 filaments/mL. The experiment was initiated by exposing the algae to 0.1, 0.2, 0.4, 0.8, and 1.6 mg/L as DDA, 0.2, 0.6, 1.0 mg Cu/L Cutrine®-Plus, and combinations of DDA and Cutrine®-Plus. Due to the low solubility of DDA, the treatment stock solution was made using a 2% DMSO solution as the solvent. The solution was heated in a water bath and diluted to 70 mg/L using warmed deionized water. The concentration of DMSO was approximately 350 mg/L in the test beakers. Cutrine®-Plus stock solution was made at 50 mg/L using deionized water. Three replicates of each exposure concentration, along with three replicates of an untreated reference were tested. Each sample was maintained at room temperature with 12-hours of light and 12-h dark photoperiod. The results are shown in TABLE 7 and shows the fresh weight biomass of Cladophora sp. 15 days after exposure.

TABLE 7
Extracted chlorphylll a concentrations (μg/sample) of C. kosterae cultures

| | BADA | | | | | | | | Cutrine ® | Control |
|---|---|---|---|---|---|---|---|---|---|---|
| Time | 0.2 | 0.4 | 0.8 | 1.0 | 1.2 | 1.4 | 1.8 | 2.0 | Plus | 0 |
| (days) | ppm | ppm | ppm | ppm | ppm | ppm | ppm | ppm | ppm | ppm |
| 0 | 14.21 | 14.21 | 14.21 | 14.21 | 14.21 | 14.21 | 14.21 | 14.21 | 14.21 | 14.21 |
| 14 | 11.01 | 13.15 | 12.54 | 13.26 | 11.15 | 8.63 | 8.70 | 8.32 | 10.39 | 18.62 |

As can be seen from Examples 4 and 5, N,N-bis-(3-aminopropyl) dodecylamine is effective as an algaecide on both Microcystis aeruginosa and Cladophora sp. at concentrations comparable to the copper containing algaecide Cutrine®-Plus. Chlorophyll a content of M. aeruginosa by 15 days after start showed that the application of BADA at concentrations of 0.2 to 2.0 ppm (mg/L) reduced (p<0.01) chlorophyll when compared to untreated control algae.

### Example 6

Example 5 was repeated but using the N,N-bis-(3-aminopropyl) dodecylamine in the amounts of 200 parts per billion ((ppb) 0.2 ppm), 100 parts per billion ((ppb) 0.1 ppm), 75 parts per billion ((ppb) 0.075 ppm), 50 parts per billion ((ppb) 0.05 ppm), and 25 parts per billion ((ppb) 0.025 ppm). A control example was also repeated since the M. aeruginosa was from a different culture and the test were conducted at different times. The results are shown in TABLES 8, and 9, which show the chlorophyll a concentration and the cell density, respectively.

TABLE 8
In vivo chlorophyll a concentrations
(μg/L) of M. aeruginosa cultures

| Time | BADA | | | | | Control |
|---|---|---|---|---|---|---|
| (days) | 200 ppb | 100 ppb | 75 ppb | 50 ppb | 25 ppb | 0 ppb |
| 0 | 1.20 | 1.20 | 1.20 | 1.20 | 1.20 | 1.20 |
| 1 | 0.50 | 0.55 | 0.50 | 0.48 | 0.67 | 0.92 |
| 5 | 0.03 | 0.03 | 0.05 | 0.04 | 0.64 | 1.99 |
| 7 | 0.02 | 0.03 | 0.05 | 0.06 | 1.58 | 3.62 |
| 12 | 0.05 | 0.31 | 0.60 | 0.71 | 7.91 | 5.86 |
| 14 | 0.16 | 0.98 | 1.77 | 1.93 | 10.06 | 4.16 |

TABLE 9
Cell density of M. aeruginosa cultures (cells/mL)

| Time | BADA | | | | | Control |
|---|---|---|---|---|---|---|
| (days) | 200 ppb | 100 ppb | 75 ppb | 50 ppb | 25 ppb | 0 ppb |
| 0 | 3.8E+05 | 3.8E+05 | 3.8E+05 | 3.8E+05 | 3.8E+05 | 3.8E+05 |
| 14 | 1.4E+05 | 8.7E+05 | 1.4E+06 | 1.5E+06 | 7.3E+06 | 3.9E+06 |

While the invention has been described above with references to specific embodiments thereof, it is apparent that many changes, modifications and variations can be made without departing from the invention concept disclosed herein.

Accordingly, it is intended to embrace all such changes, modifications, and variations that fall within the spirit and broad scope of the appended claims.

What is claimed is:

1. A method of controlling algae in a body of water on the earth surface, said method comprising adding a composition containing an amine or a salt of an amine having general formula (1) 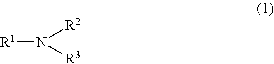
or a salt thereof
wherein
R¹ is a substituted or unsubstituted C₆₋₃₀ alkyl; and
R² and R³ are each independently a hydrogen atom, a substituted or unsubstituted hydrocarbyl group having between 1 and 20 carbon atoms, to earth surface water in an effective amount up to 4 parts per million or less, and
wherein the earth surface water is water in direct contact with the terrain of the earth and the composition is free of copper algaecide.

2. The method according to claim 1, wherein the hydrocarbyl group is a straight chain hydrocarbyl group having between 2 and 20 carbon atoms.

3. The method according to claim 1, wherein R¹ is a C₈₋₁₆ alkyl group and R² and R³ are each a hydrogen atom or amine substituted hydrocarbyl group having between 1-6 carbon atoms.

4. The method according to claim 3, wherein R¹ is a C12 alkyl group and R² and R³ are each a hydrogen atom.

5. The method according to claim 3, wherein R¹ is a C12 alkyl group and R² and R³ are each —CH₂—CH₂—CH₂—NH₂.

6. The method according to claim 1, wherein the amine is a hydrochloride salt.

7. The method according to claim 1, wherein the amine is used in an amount between 0.001 and 2.0 ppm (mg/l).

8. The method according to claim 1, wherein the amine is used in an amount between 0.01 and 1.8 ppm (mg/l).

9. The method according to claim 1, further comprising adding an additional algaecide to the body of water.

10. The method according to claim 1, further comprising adding an herbicide to the body of water.

11. The method according to claim 10, wherein the herbicide is mixed with the amine of salt of the amine to form a mixture, and the mixture is added to the body of water.

12. The method according to claim 1, wherein the amine or salt of the amine is mixed with an herbicide, a colorant, an adjunctive, another algaecide, a solvent or a mixture thereof.

13. The method according to claim 1, wherein the earth surface water contains aquatic life.

14. The method according to claim 13, wherein the earth surface water is a lake, a pond, or a canal.

15. The method according to claim 14, wherein the amine or amine salt is added in an amount of 0.01 to about 1.0 ppm, R¹ is a C12 alkyl group and R² and R³ are each —CH2—CH2—CH2—NH2.
